(19) United States
(12) Patent Application Publication
(10) Pub. No.: US 2004/0070272 A1
(43) Pub. Date: Apr. 15, 2004

(54) Method for performing the function "constant speed on the gradient"

(76) Inventors: Bernhard Grupp, Weingarten (DE); Bernhard Reisch, Isny (DE); Frank Sauter, Meckenbeuren (DE); Peter Schmidtner, Lindau (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/466,979

(22) PCT Filed: Jan. 19, 2002
(86) PCT No.: PCT/EP02/00532

(30) Foreign Application Priority Data
Jan. 24, 2001 (DE) 101 03 013.4

(51) Int. Cl. B60T 8/18

(52) U.S. Cl. 303/198

(57) ABSTRACT

When performing the function of “constant speed on the gradient”, the necessary braking power is determined as a function of the vehicle's loading.

The present invention concerns a method for performing the function “constant speed on the gradient” for a motor vehicle, according to the preamble of claim 1.

In the present state of the art, the regulation or control of the braking power during the “constant speed on the gradient” operating mode is based on a defined set of parameters designed essentially for the main application “vehicle loaded” and for a steep gradient.

This design can lead to discomfort in the case of mild gradients and partially loaded or empty vehicles since, in such a situation, the vehicle tends to over-brake markedly.

Besides, when this function is implemented, an empty vehicle reacts too violently and quickly because of its low weight and high braking power, and this is uncomfortable.

On the other hand, if the regulation or control system is designed for a mild gradient and an empty vehicle, this results in too large a speed deviation from the desired speed when the vehicle is fully loaded or when the gradient is steep.

The purpose of this invention is, therefore, to indicate a method for performing the function “constant speed on the gradient”, which ensures comfortable braking without speed deviation regardless of the loading of the vehicle and the topography.

This objective is achieved by the characteristics of claim 1. Other features emerge from the subordinate claims.

According to these, it is proposed to determine the necessary braking power as a function of the vehicle's weight, including the loading of the vehicle.

For this, according to an embodiment of the present invention several sets of parameters for regulation and control purposes are stored, which are appropriate for various vehicle weights, and the actual vehicle weight is determined or calculated.

In a variant of this invention, characteristic lines or performance graphs are used for the individual parameters as a function of the vehicle weight.

Besides the vehicle weight, the topography can be taken into account in the adaptation of the parameters on their characteristic lines, by virtue of a navigation system, for example a GPS device.

The method proposed here avoids the disadvantages of the prior art, so that comfortable braking, without speed deviation, is made possible regardless of the loading of the vehicle and the topography.

1. Method for performing the function “constant speed on the gradient”, characterized in that the necessary braking power is determined as a function of the vehicle's weight, including the loading of the vehicle.

2. Method according to claim 1, characterized in that several sets of parameters for regulation and control purposes are stored, which are appropriate for various vehicle weights.

3. Method according to claim 2, characterized in that characteristic lines or performance graphs are used for the individual parameters, as a function of the vehicle's weight.

4. Method according to claims 2 or 3, characterized in that the actual vehicle weight is determined or calculated.

5. Method according to any of claims 1 to 4, characterized in that the necessary braking power is also determined as a function of the topography.

6. Method according to claim 5, characterized in that the topography is taken into account in the adaptation of the parameters or characteristics by means of a navigation system.
